(19) United States
(12) Patent Application Publication
(10) Pub. No.: US 2026/0211636 A1
(43) Pub. Date: Jul. 23, 2026

(54) CONSTRAINING LARGE LANGUAGE MODEL GENERATION USING INCREMENTAL ANALYSIS

(71) Applicant: SAP SE, Walldorf (DE)

(72) Inventors: Abdelaziz Ben Othman, Berlin (DE); Kai Patrick Reisert, Hemsbach (DE); Niklas Loeser, Heidelberg (DE); Martin Kraemer, Limburgerhof (DE)

(21) Appl. No.: 19/033,838

(22) Filed: Jan. 22, 2025

(51) Int. Cl. G06F 8/35; G06N 3/0475

(52) U.S. Cl. CPC G06F 8/35; G06N 3/0475

(57) ABSTRACT

In an example embodiment, constrained generation during LLM inference is performed using a multi-layered approach to incremental parsing. This constrained generation process is able to more effectively generate computer code for sentence-based programming languages. Specifically, it is designed to wait until a full statement is generated prior to analyzing the syntactical correctness of a statement, because the meaning of a token in a sentence-based programming language can change its meaning based on later tokens in the same statement. Furthermore, the external (block) structure of statements can be analyzed by looking only at the first word of statements without looking into the statements more closely.

### TECHNICAL FIELD

This document generally relates to computer systems. More specifically, this document relates to constraining large language model generation using incremental analysis.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for constrained generation flow in an LLM 100, accordance with an example embodiment.

FIG. 2 is a flow diagram illustrating a method of generating a code sequence using an LLM, in accordance with an example embodiment.

FIG. 3 is a block diagram illustrating an architecture of software for embedding searches, which can be installed on any one or more devices.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

The recent advancements in Artificial Intelligence (AI) and Natural Language Processing (NLP) gave rise to the development of different code generation tools using Large Language Models (LLMs). Such tools come in different variations: while some of them can be integrated into the development environment to make real-time code suggestions (e.g., the Copilot IDE plugin by GitHub, Inc. of San Francisco, CA), others provide a chat interface (e.g., ChatGPT by OpenAI, Inc. of San Francisco, CA) that the developers can interact with. These tools have the potential to increase the productivity of developers by accelerating the development process and helping the developers with different features of a programming language, even if they have not used the language before.

In order for such code-generation tools to operate effectively, generated code needs to be ensured that it is both syntactically and semantically correct. Otherwise, developers wind up having to fix broken code generated by the LLM, which can take more time than writing the code from scratch.

While such code generation tools may work well for programs in typical programming languages, such as Python, they are not reliable for atypical programming languages. This is for several reasons. First of all, atypical programming languages are rarer and thus the available training data to train an LLM based on such an atypical programming language is also rarer. Second of all, some atypical programming languages are sentence based. Sentence-based programming languages are designed in a way that the program code looks like a sequence of natural language sentences, with, for example, statements separated by periods. While the natural language similarity would seem to make it a natural fit for LLMs to generate sentence-based programming code, at a technical level there are many technical issues involved in doing so.

Specifically, sentence-based programming languages contain a lot more unique keywords that have meaning when placed in specific positions within the sentences. For example, in Advanced Business Application Programming (ABAP), which is a programming language created by SAP™ SE of Walldorf, Germany, there are roughly a thousand distinct words that can act like keywords if used in certain syntax structures, but otherwise can also act as identifiers (not reserved keywords). In contrast, Python has fewer than forty keywords. The result is that when using an LLM to generate code in a sentence-based programming language, the LLM will tend to hallucinate a keyword or a syntactic construct that is not actually part of the language.

In sentence-based programming languages, a syntactically correct program is also more likely to be semantically correct, because a lot of the functionality is provided through syntactic constructs rather than through a standard library. For the same reason, multiple versions of the language, such as a language where new features are added over time or certain features are restricted due to certain programming environments, results in different syntactic constructs being available in different versions. For example, in ABAP, the language scope is restricted for development in the cloud.

In an example embodiment, constrained generation during LLM inference is performed using a multi-layered approach to incremental parsing. This constrained generation process is able to more effectively generate computer code for sentence-based programming languages. Specifically, it is designed to wait until a full statement is generated prior to analyzing the syntactical correctness of a statement, because the meaning of a token in a sentence-based programming language can change its meaning based on later tokens in the same statement. Furthermore, the external (block) structure of statements can be analyzed by looking only at the first word of statements without looking into the statements more closely.

This approach allows LLM tokens to be passed as fragments to a scanner one-by-one as they are generated by the LLM. When the first words of a new statement are encountered, the process checks whether it opens or closes a block and validates the block structure. If the token represents a keyword that is not allowed in a given version of the language (e.g., it is restricted), then this can also be detected here, and the token may be immediately rejected and regenerated by the LLM. When a statement terminator (e.g., a ".") is encountered as a token, the inner structure of the statement as a whole can be analyzed, and if the statement is not valid according to the grammar of the language, either the complete statement can be rejected and the LLM process restarted at the end of the previous statement, or the token that causes the syntax error can be rejected and the LLM process restarted from there.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance. The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

Regardless of the type of LLM used, the LLM performs an iterative process to generate tokens (usually one token per iteration). At each iteration, the LLM outputs logits, which are raw unnormalized scores for each token in is vocabulary. These logits represent how likely the LLM thinks each token in the vocabulary should be the next one in the output sequence. These logits may be normalized by a softmax layer to generate a probability distribution for the possible tokens. The higher the normalized logit score, the higher the probability of the corresponding token being the token that "should" be generated next. The term "should" is used here because the tokens are not necessarily selected based on highest logit scores. In the LLM, a logit processor may operate the softmax layer but can generally perform additional tasks to alter the probability distribution based on various parameters, such as to introduce variety in the output (so that the output is non-deterministic, such that the same input to the LLM twice will not result in the same output).

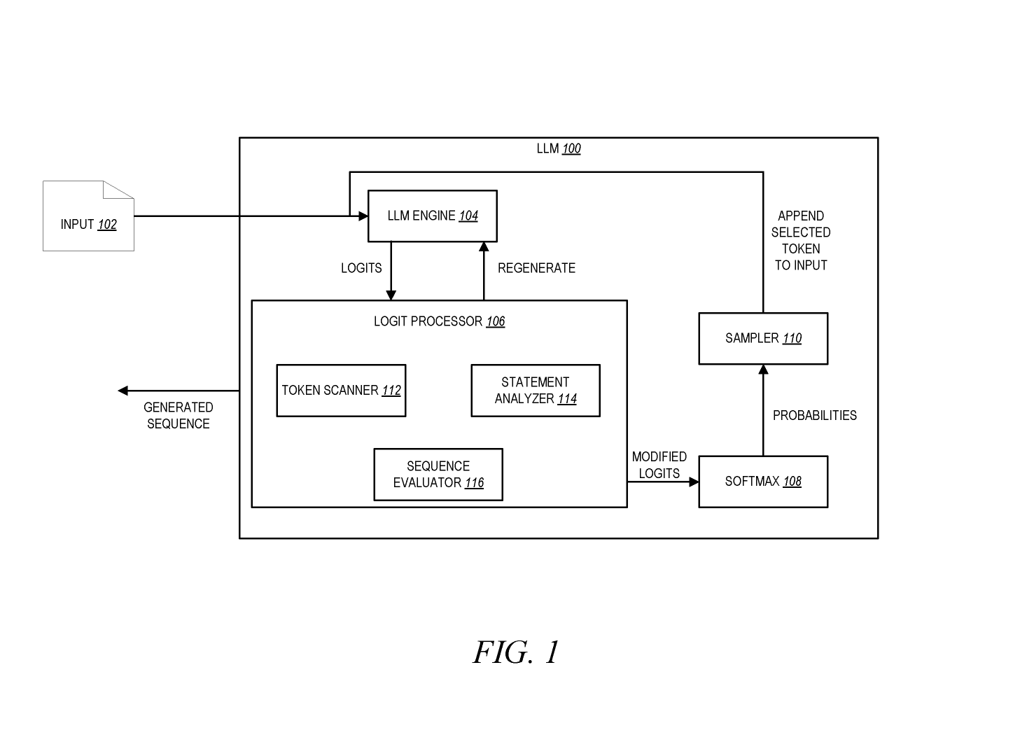

FIG. 1 is a block diagram illustrating a LLM 100 using constrained generation flow, in accordance with an example embodiment. Here, input 102 to the LLM 100 may include a sentence-based code block. This code block may be code in which a user may wish to add LLM-generated code. As such, this code block may include a prefix portion (the portion of the code before the current position of the cursor, for example) and a suffix portion (the portion of the code after the current position of the cursor). The current position of the cursor may indicate the location in the code in which the user wishes to add LLM-generated code. The prefix portion and the suffix portion thus act as context for an LLM prompt that prompts the LLM 100 to perform the generation.

The generation may begin by using an LLM engine 104. The LLM engine 104 may include, for example, a neural network that generates logits for each token in a vocabulary based on the prompt and the prefix and suffix. The resultant logits are then passed to a logit processor 106.

In an example embodiment, the logit processor 106 is customized to take the raw logits from the LLM engine 104 and modify them to enforce constraints. This includes suppressing invalid tokens. The output of the logit processor 106 is a modified set of logits that reflects the constraints.

The modified logits are then passed through a softmax function 108, which converts them into a probability distribution over the vocabulary. Each token now has a probability value, representing the likelihood of it being selected as the next token.

A sampler 110 then uses a sampling strategy (e.g., greedy decoding, nucleus sampling, beam search, etc.) to select the next token based on the probability distribution. The selected token is then appended to the input sequence, forming new input for the next iteration.

This feedback loop continues until a stopping condition is met, such as an end-of-sequence token is generated or a maximum token limit is reached.

The logit processor 106 may include a token scanner 112 and a statement analyzer 114. Assuming the most recently generated token is not the last token in the generated sequence, then the generated token is passed to the token scanner 112. The token scanner 112 determines whether the token itself is valid. This could include, for example, determining whether the token is valid based on a specified grammar. No matter how the determination is performed, however, what is happening here is the token is immediately known as an invalid token, without needing to know future generated tokens in the sequence. As mentioned earlier, that is not always the case in sentence-based programming languages, where in some cases a later-generated token affects the meaning of an earlier-generated token. Such an alteration in the meaning of an earlier-generated token will be handled later in the process.

It should be noted that sentence-based programming languages such as ABAP allow for multiple grammars. For example, a language can evolve over time, resulting in multiple versions of the language, as well as different permissible grammars in different scenarios (such as the aforementioned use case where a restricted version of the grammar is used in cloud environments). These grammars may be enforced on a per-statement basis, meaning that conceivably each statement within a generated token sequence could potentially have a different grammar being enforced. Thus, the checking that is performed by the token scanner is based on a grammar that is defined for the statement and enforced for that statement, but the enforced grammar may change when the next statement begins to be generated.

If the token scanner 112 determines that the generated token is invalid, it may be immediately rejected. As will be described in more detail layer, a rejected token may have its associated originally assigned logit overwritten with a new logit that causes the logit processor to not select it. This may include, for example, overwriting the originally assigned logit with a logit of negative infinity, zero, or a null value, such that there is no chance that the sampler 110 selects the token. For ease of discussion, the negative infinity, zero, or null value shall be referred to as an "invalidating value" for the logit, as it causes a token corresponding to the logit to be invalid as a selection by the logit processor 106. It should be noted that in some implementations a logit value of 0 may not be enough to cause the token to be unselected, as logit values are relative. In such embodiments, a very large negative logit value such as -100 or negative infinity may be assigned.

Once a valid token has been generated, the logit processor 106 may determine whether the statement is complete. There typically would be a token or other end-of-statement marker that is generated to indicated that the statement is compete. For example, in a sentence-based programming language, such as an end-of-statement is indicated by a period. Thus, if the generated token is a period, it can be assumed that the token represents the final token in the statement. If the generated token is not the end-of-statement, then the loop continues.

This process repeats until the end of the statement is reached. At that point, the statement analyzer 114 analyzes the statement as a whole (including all of the tokens within the statement) to determine whether the statement is valid. This may be performed by parsing the entire statement and analyzing the parsed statement. How this is performed will vary based on the language. As mentioned previously, however, the grammar enforced can vary based on the statement. The key aspect here, however, is that the meaning of previously generated tokens in the statement may have been changed by later-generated tokens in the statement. This is the place where those earlier meanings can be re-evaluated.

If the statement as a whole is not valid, there are a few options on how to proceed. In some example embodiments, the entire statement is simply thrown out and regenerated from the beginning. This would involve, for example, already generated tokens need to be removed from the output sequence and the LLM 100 is instructed to generate different tokens during the next attempt. In some example embodiments, if a particular earliest offending token (the earliest token in the statement that violates the grammar, based on the meanings of all tokens in the statement) can be identified, then that earliest offending token and all subsequently generated tokens in the statement are thrown out.

The process can then repeat until a valid statement is generated. Once that has taken place, tokens in the next statement can be generated. Notably, this continues until, as mentioned before, an end-of-sequence token or indication is reached. Once that has occurred, a sequence evaluator 116 evaluates the sequence as a whole to determine whether it is complete. Rather than using grammar checking at this point, however, the focus of the sequence evaluator 116 is to identify whether there are the generated sequence represents a complete program or function. This may be determined by examining whether the blocks in the sequence are balanced. If, for example, an opening block statement has been generated that does not have a corresponding closing block statement, then the blocks are considered unbalanced and the sequence is not complete, despite the receipt of an end-of-sequence indication. An example of this would be an "if" statement with no corresponding "then" statement.

If it is determined than the sequence as a whole is not complete, then the end-of-sequence token itself can be rejected, such as by overwriting its logit with an invalidating value and the logit generator instructed to generate a new token in the place of the end-of-sequence token and to continue generating tokens until an end-of-sequence token is generated. Once only the sequence as a whole is considered complete can the sequence be considered to be finished and returned as an LLM-generated code block for insertion between the prefix and the suffix in the user's code.

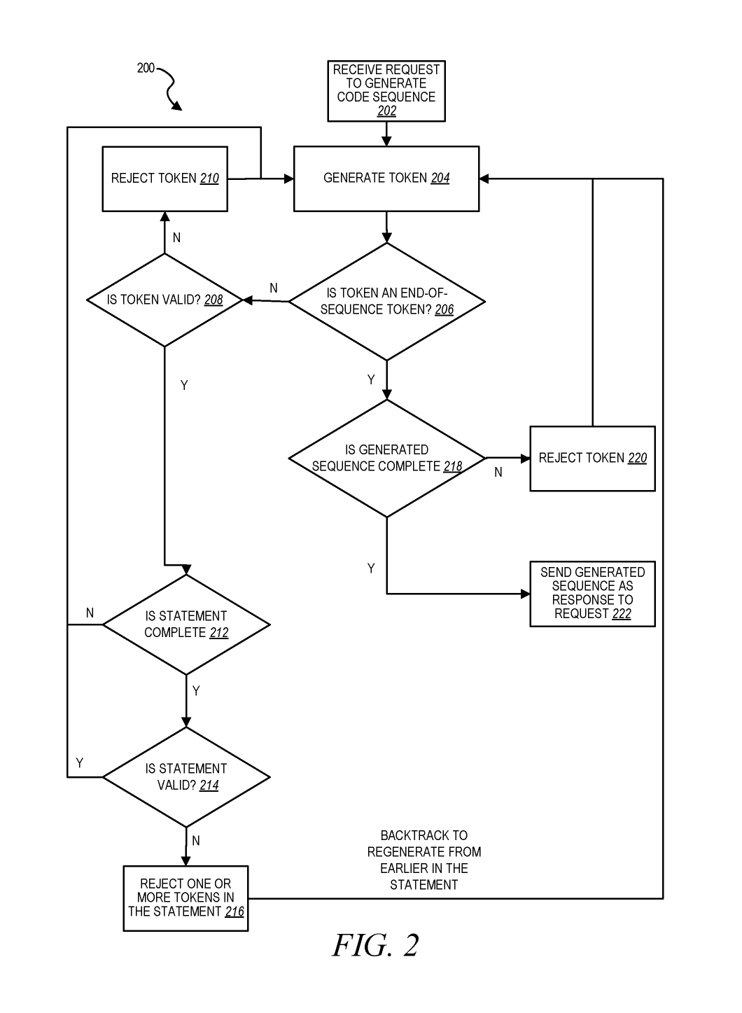

FIG. 2 is a flow diagram illustrating a method 200 of generating a code sequence using an LLM, in accordance with an example embodiment. At operation 202, a request to generate a code sequence is received. This may include, for example, a prefix and a suffix. A loop is then begun to sequentially generate tokens in statements until the complete sequence is generated. At operation 204, a token is generated. As mentioned before, this may include generating logits for each possible token in a grammar corresponding to a statement being generated and selecting a token based on these logits. At operation 206, it is determined if the generated token is an end-of-sequence token. If not, then at operation 208 it is determined if the generated token is valid (based on just looking at the generated token and the grammar for the corresponding statement). If the token is not valid, then at operation 210 the token is rejected (such as by setting its logit value an invalidating value) and the method 200 loops back to operation 204 to regenerate the just-generated token.

If at operation 208 it is determined that the token was valid, then at operation 212 it is determined whether the statement in which the token was generated is now complete. This may be indicated by, for example, the token being a period. If the statement is not complete, then the method 200 loops to operation 204 to generate the next token in the statement.

If the statement is complete, then at operation 214 it is determined if the statement is valid. This may involve comparing the statement as a whole to the grammar corresponding to the statement, and potentially reexamining the meaning of earlier-generated tokens in the statement based on the meaning of later-generated tokens in the statement. If the statement is valid, then the method 200 loops to operation 204 to begin the next statement in the code sequence. If the statement, however, is not valid, then one or more tokens in the statement is rejected at operation 216 and the method backtracks to regenerate tokens beginning at earlier in the statement.

If at operation 206 it is determined that the token is an end-of-sequence token, then at operation 218 it is determined if the generated sequence is complete. This may include checking to see if there are any open blocks in the generated sequence. If it is determined that the generated sequence is not complete, then at operation 220 the end-of-sequence token is rejected (such as by setting its logit value an invalidating value) and the method 200 returns to operation 204 to continue generating other tokens. If it is determined that the generated sequence is complete 218, then at operation 222 the generated sequence is sent as a response to the request.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: receiving, at a large language model (LLM), a request to generate a computer programming code sequence; causing generation of a statement in the computer programming code sequence by: generating a token based on the request and based on any earlier generated tokens responsive to the request; determining whether the generated token is valid; in response to a determination that the generated token is valid, determining that the generated token is a last token in a statement; in response to the determining that the generated token is the last token in the statement, analyzing the statement to validate that the statement conforms to a grammar corresponding to the statement; in response to a determination that the statement does not conform to the grammar corresponding to the statement, causing at least a portion of the statement to be regenerated until a statement is generated that does confirm to the grammar.

In Example 2, the subject matter of Example 1 comprises, wherein the operations further comprise: generating an end-of-sequence token; in response to the generation of the end-of-sequence token, validating the computer programming code sequence is complete; and in response to a determination that the computer programming code sequence is not complete, rejecting the end-of-sequence token and repeating the causing generation.

In Example 3, the subject matter of Example 2 comprises, wherein the computer programming code sequence is determined to be not complete if it contains at least one statement with an opening block without containing a corresponding statement with a closing block.

In Example 4, the subject matter of Examples 1–3 comprises, wherein the grammar for one statement in the computer programming code sequence is different than the grammar for another statement in the computer programming code sequence.

In Example 5, the subject matter of Examples 1–4 comprises, wherein the causing generation further comprises: in response to a determination that the generated token is invalid, assigning a logit value of the invalidating value to the generated token and repeating the generating of the token.

In Example 6, the subject matter of Examples 1–5 comprises, wherein the causing at least a portion of the statement to be regenerated is performed by causing regeneration of all tokens in the statement.

In Example 7, the subject matter of Examples 1–6 comprises, wherein the causing at least a portion of the statement to be regenerated is performed by causing regeneration of all tokens subsequent to an earliest invalid token in the statement.

In Example 8, the subject matter of Examples 1–7 comprises, wherein the computer programming code sequence is written in a sentence-based programming language.

In Example 9, the subject matter of Examples 1–8 comprises, wherein the request comprises a prefix of computer programming code and a suffix of computer programming code, wherein the causing generation is based on the prefix and the suffix, and wherein the generated sequence is inserted between the prefix and the suffix.

Example 10 is a method comprising: receiving, at a large language model (LLM), a request to generate a computer programming code sequence; causing generation of a statement in the computer programming code sequence by: generating a token based on the request and based on any earlier generated tokens responsive to the request; determining whether the generated token is valid; in response to a determination that the generated token is valid, determining that the generated token is a last token in a statement; in response to the determining that the generated token is the last token in the statement, analyzing the statement to validate that the statement conforms to a grammar corresponding to the statement; in response to a determination that the statement does not conform to the grammar corresponding to the statement, causing at least a portion of the statement to be regenerated until a statement is generated that does confirm to the grammar.

In Example 11, the subject matter of Example 10 comprises, generating an end-of-sequence token; in response to the generation of the end-of-sequence token, validating the computer programming code sequence is complete; and in response to a determination that the computer programming code sequence is not complete, rejecting the end-of-sequence token and repeating the causing generation.

In Example 12, the subject matter of Example 11 comprises, wherein the computer programming code sequence is determined to be not complete if it contains at least one statement with an opening block without containing a corresponding statement with a closing block.

In Example 13, the subject matter of Examples 10–12 comprises, wherein the grammar for one statement in the computer programming code sequence is different than the grammar for another statement in the computer programming code sequence.

In Example 14, the subject matter of Examples 10–13 comprises, wherein the causing generation further comprises: in response to a determination that the generated token is invalid, assigning a logit value of the invalidating value to the generated token and repeating the generating of the token.

In Example 15, the subject matter of Examples 10–14 comprises, wherein the causing at least a portion of the statement to be regenerated is performed by causing regeneration of all tokens in the statement.

In Example 16, the subject matter of Examples 10–15 comprises, wherein the causing at least a portion of the statement to be regenerated is performed by causing regeneration of all tokens subsequent to an earliest invalid token in the statement.

In Example 17, the subject matter of Examples 10–16 comprises, wherein the computer programming code sequence is written in a sentence-based programming language.

In Example 18, the subject matter of Examples 10–17 comprises, wherein the request comprises a prefix of computer programming code and a suffix of computer programming code, wherein the causing generation is based on the prefix and the suffix, and wherein the generated sequence is inserted between the prefix and the suffix.

Example 19 is a non-transitory machine-readable medium storing instructions which, when executed by one or more processors, cause the one or more processors to perform operations comprising: receiving, at a large language model (LLM), a request to generate a computer programming code sequence; causing generation of a statement in the computer programming code sequence by: generating a token based on the request and based on any earlier generated tokens responsive to the request; determining whether the generated token is valid; in response to a determination that the generated token is valid, determining that the generated token is a last token in a statement; in response to the determining that the generated token is the last token in the statement, analyzing the statement to validate that the statement conforms to a grammar corresponding to the statement; in response to a determination that the statement does not conform to the grammar corresponding to the statement, causing at least a portion of the statement to be regenerated until a statement is generated that does confirm to the grammar.

In Example 20, the subject matter of Example 19 comprises, generating an end-of-sequence token; in response to the generation of the end-of-sequence token, validating the computer programming code sequence is complete; and in response to a determination that the computer programming code sequence is not complete, rejecting the end-of-sequence token and repeating the causing generation.

Example 21 is at least one machine-readable medium comprising instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

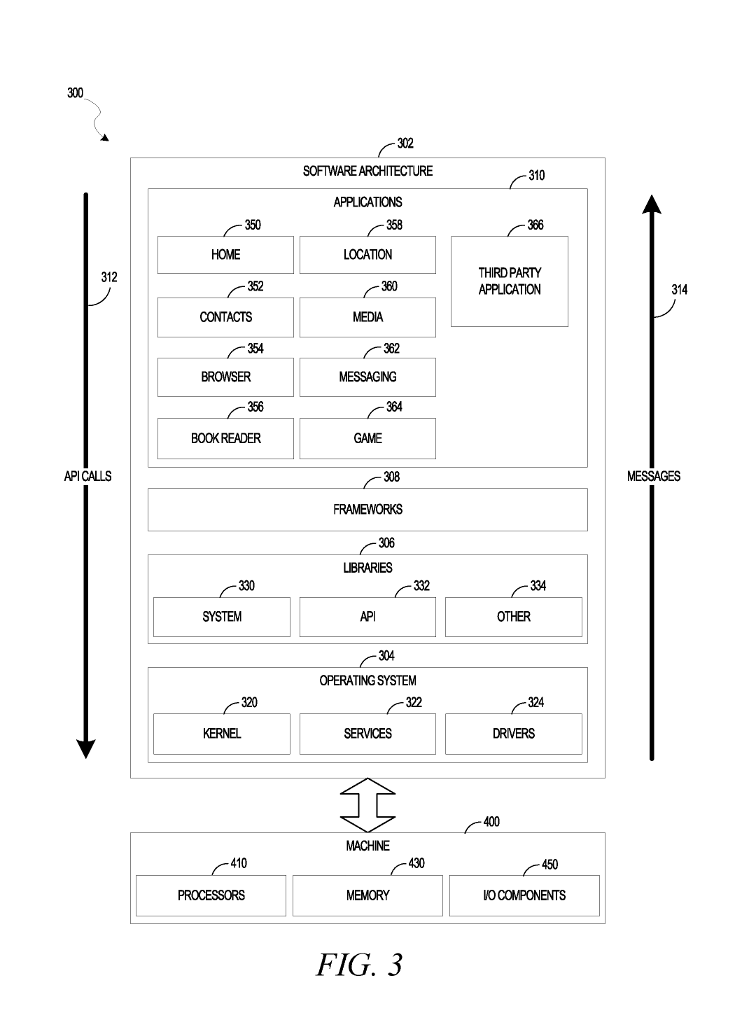

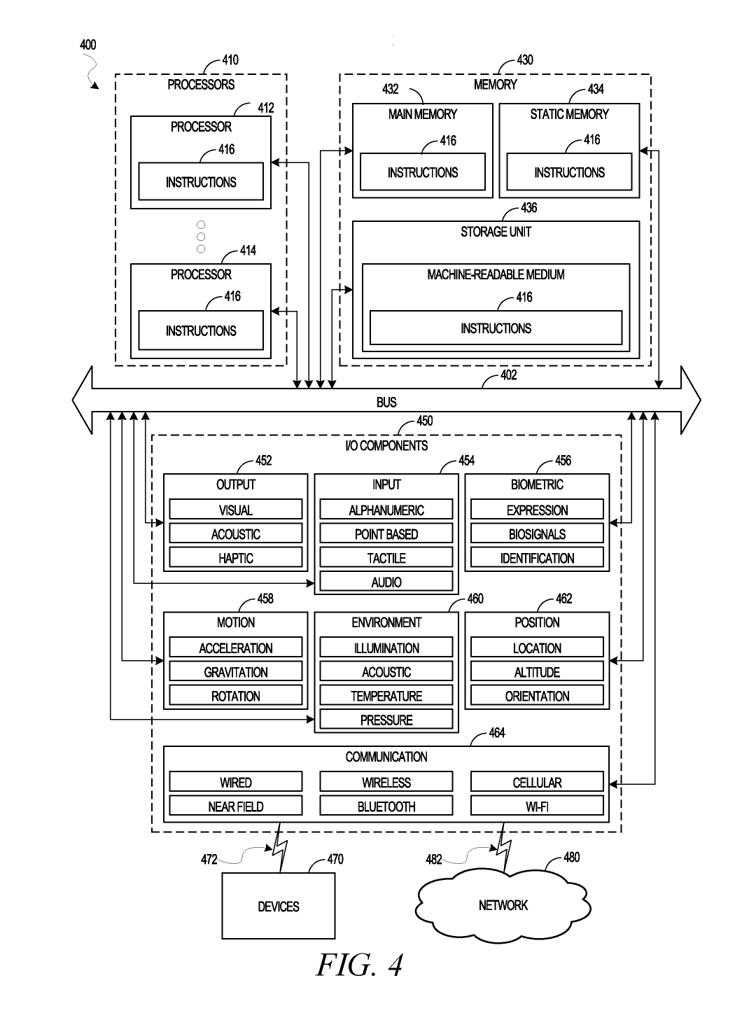

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various GUI functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 and send messages 314 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method 200 of FIG. 2. Additionally, or alternatively, the instructions 416 may implement FIGS. 1-2 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor’s cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., HTTP). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, at a large language model (LLM), a request to generate a computer programming code sequence;
causing generation of a statement in the computer programming code sequence by:
generating a token based on the request and based on any earlier generated tokens responsive to the request;
determining whether the generated token is valid;
in response to a determination that the generated token is valid, determining that the generated token is a last token in a statement;
in response to the determining that the generated token is the last token in the statement, analyzing the statement to validate that the statement conforms to a grammar corresponding to the statement;
in response to a determination that the statement does not conform to the grammar corresponding to the statement, causing at least a portion of the statement to be regenerated until a statement is generated that does confirm to the grammar.

2. The system of claim 1, wherein the operations further comprise:
generating an end-of-sequence token;
in response to the generation of the end-of-sequence token, validating the computer programming code sequence is complete; and
in response to a determination that the computer programming code sequence is not complete, rejecting the end-of-sequence token and repeating the causing generation.

3. The system of claim 2, wherein the computer programming code sequence is determined to be not complete if it contains at least one statement with an opening block without containing a corresponding statement with a closing block.

4. The system of claim 1, wherein the grammar for one statement in the computer programming code sequence is different than the grammar for another statement in the computer programming code sequence.

5. The system of claim 1, wherein the causing generation further comprises:
in response to a determination that the generated token is invalid, assigning a logit value of the invalidating value to the generated token and repeating the generating of the token.

6. The system of claim 1, wherein the causing at least a portion of the statement to be regenerated is performed by causing regeneration of all tokens in the statement.

7. The system of claim 1, wherein the causing at least a portion of the statement to be regenerated is performed by causing regeneration of all tokens subsequent to an earliest invalid token in the statement.

8. The system of claim 1, wherein the computer programming code sequence is written in a sentence-based programming language.

9. The system of claim 1, wherein the request comprises a prefix of computer programming code and a suffix of computer programming code, wherein the causing generation is based on the prefix and the suffix, and wherein the generated sequence is inserted between the prefix and the suffix.

10. A method comprising:
receiving, at a large language model (LLM), a request to generate a computer programming code sequence;
causing generation of a statement in the computer programming code sequence by:
generating a token based on the request and based on any earlier generated tokens responsive to the request;
determining whether the generated token is valid;
in response to a determination that the generated token is valid, determining that the generated token is a last token in a statement;
in response to the determining that the generated token is the last token in the statement, analyzing the statement to validate that the statement conforms to a grammar corresponding to the statement;
in response to a determination that the statement does not conform to the grammar corresponding to the statement, causing at least a portion of the statement to be regenerated until a statement is generated that does confirm to the grammar.

11. The method of claim 10, further comprising:
generating an end-of-sequence token;
in response to the generation of the end-of-sequence token, validating the computer programming code sequence is complete; and
in response to a determination that the computer programming code sequence is not complete, rejecting the end-of-sequence token and repeating the causing generation.

12. The method of claim 11, wherein the computer programming code sequence is determined to be not complete if it contains at least one statement with an opening block without containing a corresponding statement with a closing block.

13. The method of claim 10, wherein the grammar for one statement in the computer programming code sequence is different than the grammar for another statement in the computer programming code sequence.

14. The method of claim 10, wherein the causing generation further comprises:
in response to a determination that the generated token is invalid, assigning a logit value of the invalidating value to the generated token and repeating the generating of the token.

15. The method of claim 10, wherein the causing at least a portion of the statement to be regenerated is performed by causing regeneration of all tokens in the statement.

16. The method of claim 10, wherein the causing at least a portion of the statement to be regenerated is performed by causing regeneration of all tokens subsequent to an earliest invalid token in the statement.

17. The method of claim 10, wherein the computer programming code sequence is written in a sentence-based programming language.

18. The method of claim 10, wherein the request comprises a prefix of computer programming code and a suffix of computer programming code, wherein the causing generation is based on the prefix and the suffix, and wherein the generated sequence is inserted between the prefix and the suffix.

19. A non-transitory machine-readable medium storing instructions which, when executed by one or more processors, cause the one or more processors to perform operations comprising:
receiving, at a large language model (LLM), a request to generate a computer programming code sequence;
causing generation of a statement in the computer programming code sequence by:
generating a token based on the request and based on any earlier generated tokens responsive to the request;
determining whether the generated token is valid;
in response to a determination that the generated token is valid, determining that the generated token is a last token in a statement;
in response to the determining that the generated token is the last token in the statement, analyzing the statement to validate that the statement conforms to a grammar corresponding to the statement;
in response to a determination that the statement does not conform to the grammar corresponding to the statement, causing at least a portion of the statement to be regenerated until a statement is generated that does confirm to the grammar.

20. The non-transitory machine-readable medium of claim 19, further comprising:
generating an end-of-sequence token;
in response to the generation of the end-of-sequence token, validating the computer programming code sequence is complete; and
in response to a determination that the computer programming code sequence is not complete, rejecting the end-of-sequence token and repeating the causing generation.
